(19) United States
(12) Patent Application Publication
(10) Pub. No.: US 2003/0067772 A1
(43) Pub. Date: Apr. 10, 2003

(54) Lazer ring pop

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Melvin L. Crane, 318 South Cleveland Street, Arlington, VA, 22204-2038, US

(21) Appl. No.: 09/973,465

(22) Filed: Oct. 10, 2001

(51) Int. Cl. F21L 4/04; F21V 33/00

(52) U.S. Cl. 362/202; 362/208; 362/253; 362/806

(57) ABSTRACT

A lazer ring pop having at least one housing section for inclusion of a power source such as one or two batteries, a bulb and a control switch. A ring support having a ring secured is connected to the at least one housing so that light can shine through the pop. The ring support can be removed and the device can be used as a regular flashlight.

### BACKGROUND OF THE INVENTION

This invention is directed to a novelty candy holding device in combination with a light source and a removable, wearable ring, and more particularly to an illuminated lazer ring pop.

### PRIOR ART

Heretofore applicants have obtained patents on different types of candy holding devices which include a flashlight with illuminated candy as set forth in U.S. Pat. No. 5,860,732.

### SUMMARY OF THE INVENTION

The present invention is directed to a candy holding device which includes a piece of candy which is illuminated for the enjoyment of a person.

The device affords one an opportunity to replace the candy with different colored candy so that a light beam will have different colors.

Another advantage is that the ring can be removable for one to wear the ring on one of their fingers separate from the flashlight.

Still another object is to provide a combination flashlight, ring, and a piece of candy for enjoyment of a user in which the parts can be separated for use of the parts separate from each other.

Other objects and advantages of the invention will become obvious to those skilled in the art upon a review of the drawings, specification and claims.

### BRIEF DESCRIPTION OF THE DRAWINGS

FIG. 1 is a side view illustrating an assembled lazer ring pop; and

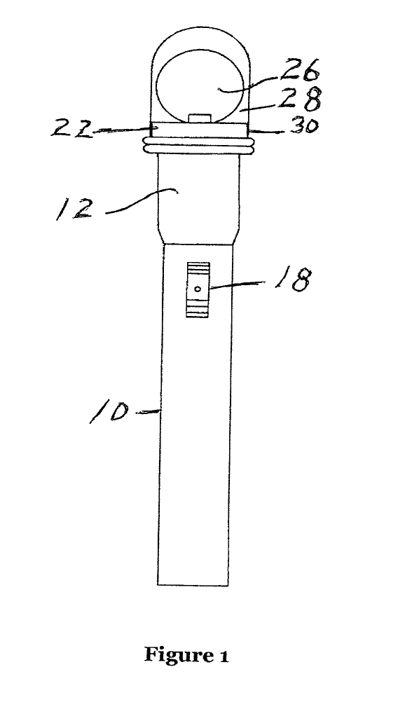

FIG. 2 is a transparent view illustrating the components of the device as assembled.

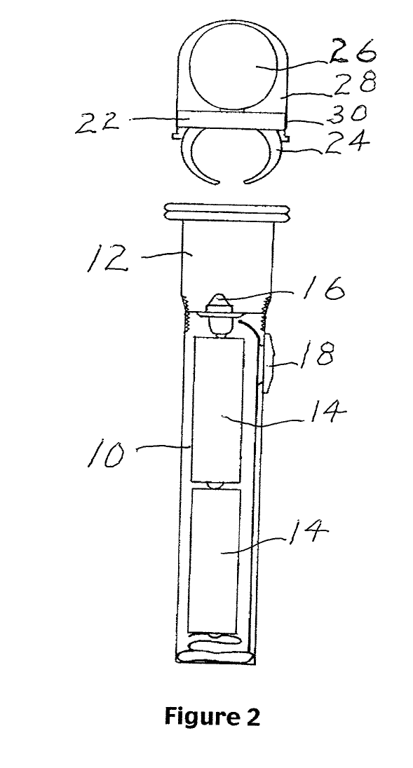

### DETAILED DESCRIPTION OF THE INVENTION

Now referring to the drawings there is shown a lazer ring pop including a two-piece housing including a lower housing 10 and an upper housing 12. The lower housing includes a power source such as by aligned small-sized batteries 14 which are electrically connected to a bulb 16 and controlled by a switch 18. It is obvious to one skilled in the art that a completed circuit is formed by a positive pole of the upper battery contacting the positive connection of the bulb and a ground wire 20 completes the circuit from the ground of the lower battery through the control switch which the ground wire connects to the ground of the light bulb. The light is controlled by the switch completing and breaking the completion of the ground wire from the ground of the lower battery to the ground of the bulb.

The upper end of the lower housing 10 has external threads to which internal threads on a lower end of the upper housing are connected to assemble the upper housing to the lower housing. The upper end of the upper housing 12 includes a locking mechanism to which a transparent ring support 22 having a ring 24 thereon is connected. Any well-known connection can be made to hold the ring and ring support to the upper end of the upper housing. A candy pop 26 supported by a stick of any type or which is molded to the ring support is shown secured to the ring support 22. A slip-on protective cover 28 having a slip-on end 30 can be slipped onto the ring support to protect the candy pop when the candy pop is not being consumed.

In order to change the batteries after the energy has been expended, the bottom of the lower housing can be provided with a removable end or the bulb holder may be made removable in order to remove the batteries once they are no longer operable.

The lazer ring pop can be provided with auxiliary parts such as a lens and lens holder that can be secured to the upper end of the upper housing after the ring holder has been removed. This would provide one with an assemblage that could be used as a separate flashlight with a protective lens. Of course the device could be used as a flashlight without the protective lens.

The candy pop can be made with a supporting stick so that once the candy has been consumed another candy pop can replace the one that was consumed by supporting the stick in a support opening in the ring holder. Further, the candy pop can be molded onto the ring support. In this way a completely new ring holder would be replaced in order to use the device with a new piece of candy.

Any suitable means may be used to secure the upper housing to the lower housing and for assembly of the ring and ring support onto the housing. Further, the device could be made with only one housing section with an upper end to which the ring support could be secured.

The foregoing relates to preferred exemplary embodiments of the invention, it being understood that other variants and embodiments thereof are possible within the spirit and scope of the invention, the latter being defined by the appended claims.

We claim:

1. A lazer ring pop which comprises at least one housing,
an electrical power source in said at least one housing,
A light means which is activated by said power source to produce a light beam,
a switch for controlling activation of said light means,
a ring supported by a first surface of a ring support means, and
said ring support means including means for securing said ring support means to an upper end of said at least one housing.

2. A lazer ring pop as set forth in claim 1, which includes
a candy piece mounted onto a second surface of said ring support means on a side of said ring support means opposite from said ring.

3. A lazer ring pop as set forth in claim 1, in which said at least one housing includes first and second housing sections,
A lower end of said second housing section being secured to an upper end of said first housing section in which said ring extends into said second housing section.

4. A lazer ring pop as set forth in claim 2, in which said at least one housing includes first and second housing sections,
A lower end of said second housing section being secured to an upper end of said first housing section in which said ring extends into said second housing section.

5. A lazer ring pop as set forth in claim 2, wherein said candy piece is mounted on a support means which is mounted onto said second surface of said ring support.

6. A lazer ring pop as set forth in claim 2, in which said candy piece is molded onto said second surface of said ring support.

7. A lazer ring pop as set forth in claim 2, in which said candy piece is secured onto a candy pop support means that is secured to said second surface of said ring support.

8. A lazer ring pop as set forth in claim 3 wherein said candy piece is mounted on a support means which is mounted onto said second surface of said ring support.

9. A lazer ring pop as set forth in claim 3, in which said candy piece is molded onto said second surface of said ring support.

10. A lazer ring pop as set forth in claim 2, which includes a cover which encloses said candy piece.

11. A lazer ring pop as set forth in claim 3, which includes a cover which encloses said candy piece.

12. A lazer ring pop as set forth in claim 4, which includes a cover which encloses said candy piece.

13. A lazer ring pop as set forth in claim 5, which includes a cover which encloses said candy piece.

14. A lazer ring pop as set forth in claim 6, which includes a cover which encloses said candy piece.

15. A lazer ring pop as set forth in claim 7, which includes a cover which encloses said candy piece.

16. A lazer ring pop as set forth in claim 8, which includes a cover which encloses said candy piece.

17. A lazer ring pop as set forth in claim 9, which includes a cover which encloses said candy piece.
